(19) United States
(12) Patent Application Publication
(10) Pub. No.: US 2020/0082236 A1
(43) Pub. Date: Mar. 12, 2020

(54) Carrier for Multiple Chip Cards

(71) Applicant: Telefonaktiebolaget LM Ericsson (publ), Stockholm (SE)

(72) Inventors: Helge Faulwetter, Übach-Palenberg (DE); Wolfgang Keller, Aachen (DE)

(21) Appl. No.: 16/306,996

(22) PCT Filed: Jul. 18, 2016
(86) PCT No.: PCT/EP2016/067037

§ 371 Date: Dec. 4, 2018

(51) Int. Cl. G06K 19/07

(52) U.S. Cl. CPC G06K 19/0721

(57) ABSTRACT

A carrier (CA) for multiple chip cards (C1, C2), in particular for multiple subscriber identity modules, SIMs, comprising: a first receptacle (R1) for receiving a first chip card (C1), a second receptacle (R2) for receiving a second chip card (C2), wherein the first and the second receptacle (R1, R2) are arranged symmetric to a central point (P).

### TECHNICAL FIELD

The present disclosure relates to chip cards such as SIM (subscriber identity module) cards of different types and/or sizes as they are used in mobile phones and in particular to a carrier for multiple chip cards.

### BACKGROUND

In mobile communications, so-called mini chip cards (mini-SIM, ISO/IEC 7810:2003, ID-000) have prevailed that have edge lengths of 15 and 25 mm. For reasons of manufacturing process optimization, these cards are usually stamped from standard cards with ID-1 format (ISO/IEC 7810:2003, ID-1), so that with respect to the manufacturing process there is virtually no difference between producing a mini-SIM or a micro-SIM etc.

Also, standard cards in ID-1 format are offered, in which the mini chip card may be pre-cut and is held through preferably three break tabs on the card body. The end user can then use the card according to their needs, either as a standard card or the mini smart card by breaking out of the ID-1 card and use it then as a conventional SIM card—such an adapter has become known from US patent U.S. Pat. No. 7,183,636 B1. Variants have also been proposed, in which the mini chip card is already punched out completely from the card body and is held only on a side facing away from the contacts on the card with an adhesive tape in the big card body.

Different mobiles may be configured to use different types and/or sizes of SIM cards—mini, micro and nano. Furthermore the programming interface for programming those SIM cards is based on a card in check-card size (ID-1). Nowadays, single adapters are available, from e.g. nano- to mini-SIM or micro- to mini-SIM.

### SUMMARY

As only adapters between selected sizes are available, it is necessary to have a set of various adapters in place which results in complicated handling to prepare cards for programming.

To ease handling of different card formats a carrier for multiple chip cards, in particular for multiple subscriber identity modules, SIMs, is proposed. The carrier comprises a first receptacle for receiving a first chip card. The carrier further comprises a second receptacle for receiving a second chip card. The first and the second receptacle preferably are arranged symmetric to a central point.

Of course, the present invention is not limited to the above features and advantages. Indeed, additional features and advantages are presented in the following detailed description, and in the accompanying drawings.

### BRIEF DESCRIPTION OF THE DRAWINGS

Further aspects and advantages will emerge from a reading of the following description given by way of illustrative and non-limitative example made with reference to the accompanying figures.

FIG. 1 shows a plan view of a carrier for multiple chip cards.

FIG. 2 shows a plan view of a carrier in which two symmetric orientations of the carrier are illustrated by overlaying them.

FIG. 3 shows the insertion of a carrier into a chip card reading device oriented with the a first end of the carrier ahead, whereas

FIG. 4 shows the insertion of the carrier into a chip card reading device oriented with an end opposite to said first end ahead.

### DETAILED DESCRIPTION

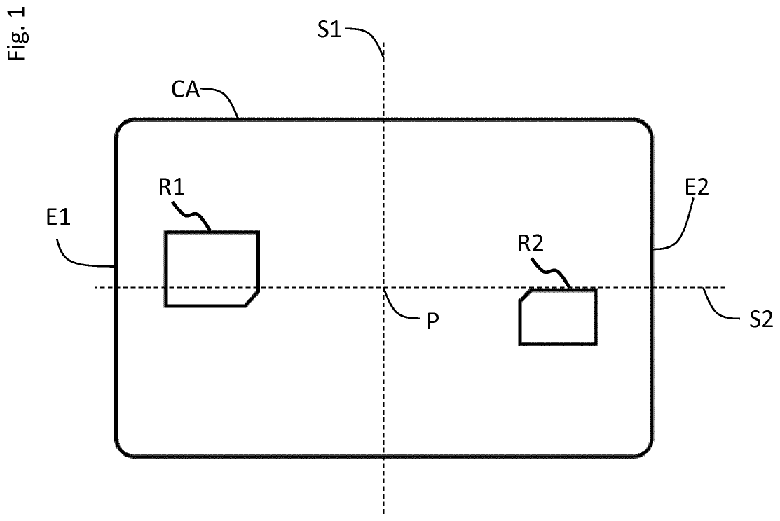

FIG. 1 schematically illustrates a carrier CA for multiple chip cards C1, C2, in particular for multiple subscriber identity modules, SIMs. The carrier CA comprises a first receptacle R1 for receiving a first chip card C1 and a second receptacle R2 for receiving a second chip card C2, wherein the first and the second receptacle R1, R2 are arranged symmetric to a central point P.

The first and the second receptacle R1, R2 are arranged symmetric, i.e. point symmetric, to a central point P of the carrier body. The first receptacle R1 serves for receiving the first chip card C1 in a press fit. The second receptacle R2 serves for receiving the second chip card C2 in a press fit. By way of the press fit the respective cards C1, C2 may be fastened to the carrier. This fastening is achieved by the friction between the respective card(s) C1, C2 and the carrier body, e.g. friction between the side walls of the receptacle R1, R2 and the side walls of the chip cards C1, C2.

The carrier preferably possesses an ID-1 identification card format according to ISO/IEC 7810:2003. As mentioned earlier such a carrier format allows for inserting the carrier into a card reading device RD as nowadays most card reading devices RD are operative to receive such a card format. It is to be understood that a card reading device RA is to be interpreted as any device being capable of reading and/writing data on the chip of a respective chipcard, may it be a mini-, micro-, nano-SIM or a full-size-SIM.

The central point may be determined by the intersection of the two axis S1 and S2 of the carrier (body). It is also noted that the carrier has two ends E1 and E2 opposite of each other. Accordingly the first chip card S1 if inserted into the first receptacle may be inserted with the first end E1 ahead into a card reading device RA in order to be operatively coupled with the card reading device RD. The same applies mutatis mutandis for the second chip card S2.

According to the embodiment shown in the figures the first and the second receptacle possess different contours. However, the carrier may have receptacles of the same contour, i.e. for receiving chip cards of the same type and/or size. With respect to the different contours this allows for receiving two cards of different contours at the same time. Furthermore, by way of a carrier having receptacles of different contours a (single) adapter may be provided that can be used for a plurality of chip card types, thus there is no need for a plurality of adaptors.

Preferably the first receptacle R1 possesses a contour for receiving a chip card C1 with a format corresponding to at least one of the following:
a mini-SIM, 2FF, according to ISO/IEC 7810:2003;
a micro-SIM, 3FF, according to ETSI TS 102 221 V9.0.0;
a nano-SIM, 4FF, according to ETSI TS 102 221 V11.0.0.

Preferably the second receptacle R2 possesses a contour for receiving a chip card C2 with a format corresponding to at least one of the following:
a mini-SIM, 2FF, according to ISO/IEC 7810:2003;
a micro-SIM, 3FF, according to ETSI TS 102 221 V9.0.0;
a nano-SIM, 4FF, according to ETSI TS 102 221 V11.0.0.

According to FIG. 1 the first receptacle R1 has the contour of a nano-SIM and the second receptacle R2 has the contour of a micro-SIM.

Especially in the case that a nano-SIM has to be programmed or read the proposed carrier CA is of advantage. In such a case it would be necessary to fit one adapter into another one to get to the right size to fit the nano-SIM it into the programming interface, i.e. card reading device, since an additional adapter or support bracket is needed to fit the nano-SIM in the receptacle for the micro-SIM. This is no longer the case with the carrier CA proposed.

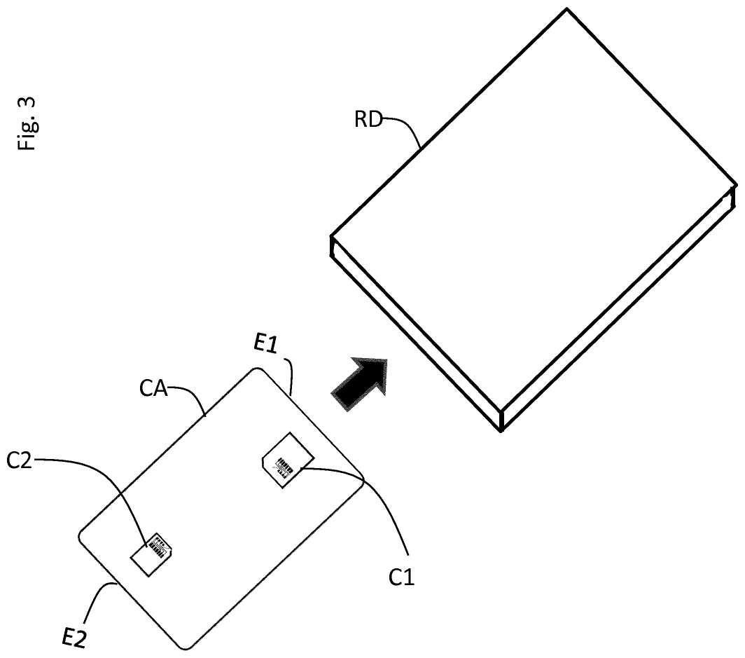

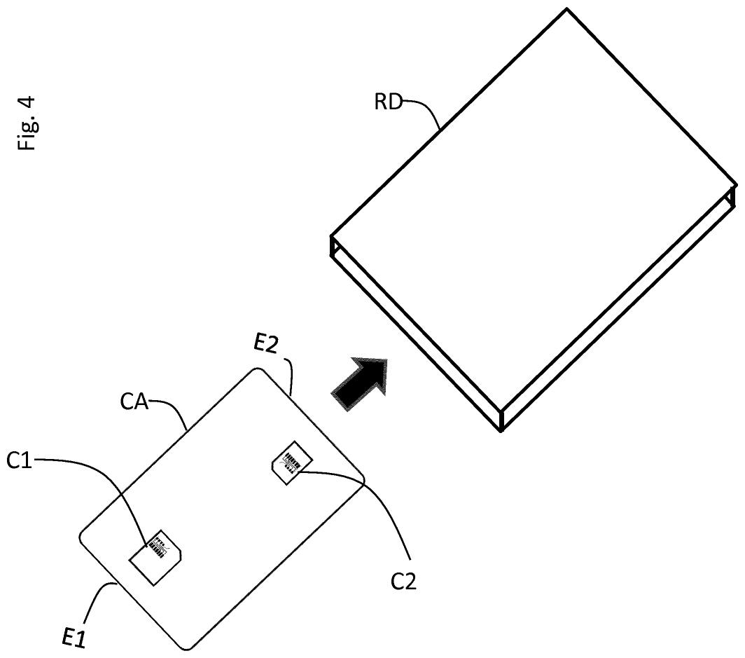

The carrier CA may serve as an adapter for inserting said first or second chip card C1, C2, respectively, e.g. dependent on the orientation of the carrier CA, into a card reading device RD. This is further illustrated in FIGS. 3 and 4. That is, the carrier CA may either be inserted with its first end E1 or its second end E2 ahead into the card reading device RD. The chip cards C1, C2 may in both orientations be contacted by the corresponding contacts of the card reading device. This is achieved by positioning the receptacles R1, R2 appropriately.

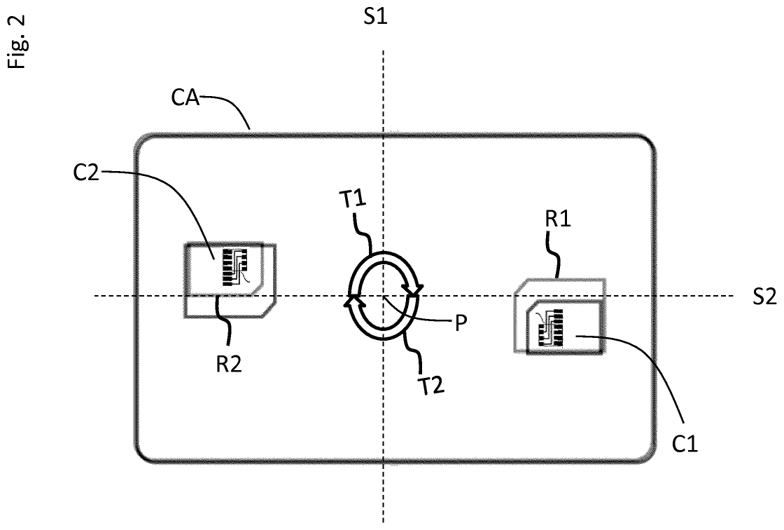

Thus, by turning and/or rotating the carrier, in particular by 180 degrees (around the central point P), the carrier can be used from both ends E1, E2 due to the symmetrical arrangement of the receptacles R1, R2. This is also illustrated in FIG. 2 where the movement to transition the carrier from a first orientation into a second orientation is illustrated as arrows T1 and T2 respectively.

Instead of rotating the carrier CA by 180 degrees around the central point P, which can be applied when the contact elements of the first and the second chip card are arranged on the same side of the carrier, the receptacles may have a contour for receiving the first and the second chip card such that the contact elements of the chip cards C1, C2 are arranged on opposite sides of the carrier CA. Such an arrangement would make it necessary for the carrier to be rotated around the axis S1 by 180 degrees.

The first and the second receptacle R1, R2 are arranged such that the contacts (contact elements) of the first and the second chip of the first and second chip card C1, C2 when inserted into the first and second receptacle R1, R2, respectively, can contact the contact pads (corresponding contact elements) of a card reading device RA, in particular a card reading device for reading an ID-1 identification card according to ISO/IEC 7810:2003.

The first and/or the second receptacle R1, R2 preferably form through holes through the carrier (body) CA. However, the first and/or the second receptacle R1, R2 may form pocket holes in the carrier (body) CA.

Altogether, it would ease the handling if the most common sizes (micro, nano) of SIM cards are merged into one adapter. Such an adapter may be used in production environment for LTE/3G/2G Mobile Networks since mobiles need SIM cards to log into Networks with dedicated authentication parameters which need to be adopted depending on tests and scenarios.

The proposed SIM adapter fits the two commonly used different SIM card sizes into one carrier. This allows flexibility in programming where different sizes of SIM cards are used. Also the maintenance and lead for reprogramming and changes is much faster as there is no need to have adapters inside adapters.

As the most common sizes are available in one card adapter, there is no need to have one card for each size or handling different adapter types. The complexity of putting adapters into adapters or to take care about different sizes is reduced by the carrier proposed. The usage of only one adapter to fit the most common sizes also guarantees better positioning and contact inside the programming interface.

The check-card size programming adapter has two receptacles. Each receptacle has the size of one commonly used SIM card—micro, nano. The position of each receptacle is exactly below the contact for the programming interface (when inserted in a card reading device RD). To swap between the different chip cards one may turn the carrier 180 degrees (counter-)clockwise.

1-13. (canceled)

14. A carrier for multiple subscriber identity modules (SIMs), comprising:
a first receptacle configured for receiving a first chip card; and
a second receptacle configured for receiving a second chip card, wherein the first and second receptacles are arranged symmetric to a central point.

15. The carrier according to claim 14, wherein the first and second receptacles are arranged symmetric to a central point of the carrier body.

16. The carrier according to claim 14, wherein the first receptacle is configured for receiving the first chip card in a press fit.

17. The carrier according to claim 14, wherein the second receptacle is configured for receiving the second chip card in a press fit.

18. The carrier according to claim 14, wherein the carrier is configured with an ID-1 identification card format according to ISO/IEC 7810:2003.

19. The carrier according to claim 14, wherein the first and second receptacles are configured with different contours.

20. The carrier according to claim 14, wherein the first receptacle is configured with a contour for receiving a chip card with a format corresponding to at least one of the following:
a mini-SIM (2FF) according to ISO/IEC 7810:2003;
a micro-SIM (3FF) according to ETSI TS 102 221 V9.0.0; and
a nano-SIM (4FF) according to ETSI TS 102 221 V11.0.0.

21. The carrier according to claim 14, wherein the second receptacle is configured with a contour for receiving a chip card with a format corresponding to at least one of the following:
a mini-SIM (2FF) according to ISO/IEC 7810:2003;
a micro-SIM (3FF) according to ETSI TS 102 221 V9.0.0; and
a nano-SIM (4FF) according to ETSI TS 102 221 V11.0.0.

22. The carrier according to claim 14, wherein the carrier is configured as an adapter for inserting the first or second chip card, respectively, dependent on the orientation of the carrier, into a card reading device.

23. The carrier according to claim 14, wherein the carrier is configured such that by turning and/or rotating the carrier by 180 degrees, the carrier is usable from both ends due to the symmetrical arrangement of the first and second receptacles.

24. The carrier according to claim 14, wherein the first and second receptacles are arranged such that the contacts of respective first and second chips of the first and second chip cards, when inserted into the first and second receptacles, respectively, contact contact pads of a card reading device, for reading an ID-1 identification card according to ISO/IEC 7810:2003.

25. The carrier according to claim 14, wherein the first and/or second receptacles form through holes through the carrier.

26. The carrier according to claim 14, wherein the first and/or second receptacles form pocket holes in the carrier.
